(19) United States
(12) Patent Application Publication
(10) Pub. No.: US 2006/0091653 A1
(43) Pub. Date: May 4, 2006

(54) System for sensing impending collision and adjusting deployment of safety device

(75) Inventors: Bernard Guy De Mersseman, Royal Oak, MI (US); Stephen Wayne Decker, Clarkston, MI (US)

Correspondence Address: AUTOLIV ASP, 3350 AIRORT ROAD, OGDEN, UT, 84405, US

(73) Assignee: Autoliv ASP, Inc.

(21) Appl. No.: 10/981,302

(22) Filed: Nov. 4, 2004

(51) Int. Cl. B60R 21/32

(52) U.S. Cl. 280/735; 701/45

(57) ABSTRACT

A system for sensing an impending collision and controlling a safety device such as an airbag in response to the detection of an impending collision target. Deployment characteristics of the safety device are adjusted based on sensor output. One implementation of the system includes a radar sensor and a vision sensor carried by the vehicle. The radar sensor provides a radar output related to the range and relative velocity of the target. The vision sensor provides a vision output related to the bearing and bearing rate of the target. An electronic control module receives the radar output and the vision output and generates control signals for control safety device and adjusting deployment characteristics.

### FIELD OF THE INVENTION

This invention relates to a system for sensing a motor vehicle impact and adjusting the deployment of a safety device.

### BACKGROUND AND SUMMARY OF THE INVENTION

Enhancements in automotive safety systems over the past several decades have provided dramatic improvements in vehicle occupant protection. Presently available motor vehicles include an array of such systems, including inflatable restraint systems for protection of occupants from frontal impacts, side impacts, and roll-over conditions. Advancements in restraint belts and vehicle interior energy absorbing systems have also contributed to enhancements in safety. Many of these systems must be deployed or actuated in a non-reversible manner upon the detection of a vehicle impact to provide their beneficial effect. Many designs for such sensors are presently used to detect the presence of an impact or roll-over condition as it occurs.

Attention has been directed recently to providing deployable systems external to the vehicle. For example, when an impact with a pedestrian or bicyclist is imminent, external airbags can be deployed to reduce the severity of impact between the vehicle and pedestrian. Collisions with bicyclists and pedestrians account for a significant number of motor vehicle fatalities annually. Another function of an external airbag may be to provide greater compatibility between two vehicles when an impact occurs. While an effort has been made to match bumper heights for passenger cars, there remains a disparity between bumper heights, especially between classes of passenger vehicles, and especially involving collisions with heavy trucks. Through deployment of an external airbag system prior to impact, the bag can provide enhancements in the mechanical interaction between the vehicles in a manner which provides greater energy absorption, thereby reducing the severity of injuries to vehicle occupants.

For any external airbag system to operate properly, a robust sensing system is necessary. Unlike crash sensors which trigger deployment while the vehicle is crushing and decelerating, the sensing system for an external airbag must anticipate an impact before it has occurred. This critical “Time Before Collision” is related to the time to deploy the actuator (e.g. 30-200 ms) and the clearance distance in front of the vehicle (e.g. 100-800 mm). Inadvertent deployment is not only costly but may temporarily disable the vehicle. Moreover, since the deployment of an airbag is achieved through a release of energy, deployment at an inappropriate time may result in undesirable effects. This invention is related to a sensing system for an external airbag safety system which addresses these design concerns.

Radar detection systems have been studied and employed for motor vehicles for many years. Radar systems for motor vehicles operate much like their aviation counterparts in that a radio frequency signal, typically in the microwave region, is emitted from an antenna on the vehicle and the reflected-back signal is analyzed to reveal information about the reflecting target. Such systems have been considered for use in active braking systems for motor vehicles, as well as obstacle detection systems for vehicle drivers. Radar sensing systems also have applicability in deploying external airbags. Radar sensors provide a number of valuable inputs, including the ability to detect the range to the closest object with a high degree of accuracy (e.g. 5 cm). They can also provide an output enabling measurement of closing velocity to a target with high accuracy. The radar cross section of the target and the characteristics of the return signal may also be used as a means of characterizing the target.

Although information obtained from radar systems yield valuable data, exclusive reliance upon a radar sensor signal for deploying an external airbag has certain negative consequences. As mentioned previously, deployment of the external airbag is a significant event and should only occur when needed in an impending impact situation. Radar sensor systems are, however, prone to “false-positive” indications. These are typically due to phenomena such as a ground reflection, projection of small objects, and software misinterpretation, which faults are referred to as “fooling” and “ghosting”. For example, a small metal object with a reflector type geometry can return as much energy as a small car and as such can generate a collision signal in the radar even when the object is too small to damage the vehicle in a substantial way. Also, there may be “near miss” situations where a target is traveling fast enough to avoid collision, yet the radar sensor system would provide a triggering signal for the external airbag.

In accordance with this invention, data received from a radar sensor is processed along with vision data obtained from a vision sensor. The vision sensor may be a stereo or a three-dimensional vision system that is mounted to the vehicle. The vision sensor can be a pair of 2 dimensional cameras that are designed to work as a stereo pair. By designing a stereo pair, the set of cameras can generate a 3 dimensional image of the scene. The vision subsystem can be designed with a single camera used in conjunction with modulated light to generate a 3 dimensional image of the scene. This 3 dimensional image is designed to overlap the radar beams so that objects will be sensed within the same area. Both the radar and 3 dimensional vision sensors measure a range to the sensed object as one of their sensed features. Since this is the common feature, it is used to correlate information from each sensor. This information correlation is important for correct fusion of the independently sensed information especially in a multiple target environment. The fusion of radar and vision sensing systems data provide a highly reliable non-contact sensing of an impending collision. The fusion mechanism is the overlap of radar range and vision depth information. The invention functions to provide a signal that an impact is imminent. This signal of an impending crash is generated from an object approaching the vehicle from any direction in which the sensor system is installed. In addition to an indication of impending crash, the sensor system will also indicate the potential intensity of the crash. The exact time of impact, and the direction of the impact is also indicated by this fused sensor system. The intensity of the crash is determined by the relative size of the striking object, and the speed with which the object is approaching the host vehicle. The time, and direction of the impact is determined by repeated measurements of the object's position. This sequence of position data points can be used to compute an objects trajectory, and by comparing this trajectory with that of the host vehicle, a point of impact can be determined. The closing velocity can also be determined by using the position data and trajectory calculations.

By sensing and notifying the safety system of an imminent crash, this sensor enables the safety system to prepare for the impact prior to the impact. The safety system can tighten the seat belts by activating an electric pre-tensioner, which makes the seat belt system more effective at restraining the occupant after contact with the object, and during the deceleration force of the crash. The advanced warning of a frontal crash can be used to inflate a larger airbag at a much slower rate. The slower rate would reduce the potential of injury by the inflating airbag, and the larger size would offer a higher level of potential energy absorption to the occupant, compared to a smaller bag. Other advantages of the forward-looking application of this sensor are the ability to deploy additional structures or modify existing structures to maximize occupant safety. These structures could be expanding bumpers or additional frame rails or pressurized body components that would add a level of safety just prior to impact during a crash.

Additional time to deploy enables safety devices that are slow in comparison to today's airbags. The seating position and headrest position can be modified, based on advanced crash information to increase their effectiveness in a variety of crash scenarios. Electric knee bolster extenders can be enabled to help hold the occupant in position during a crash. Advance warning also enables the windows and sunroof to close to further increase crash safety. External structures can be modified with advance notice of an impending crash. Structures such as extendable bumpers and external airbags can be deployed to further reduce the crash forces transmitted to the vehicle's occupants.

The system can be used in a side looking application with additional benefit to occupant safety in side crash scenarios. Knowing that a side impact will occur in advance of contact allows the side airbag to achieve similar benefit that the front airbags achieved with activation prior to impact. Such advanced activation would allow larger side bags and side curtains to deploy at slower, less aggressive rates. In a case where the contact based side airbag activation might trigger late in the crash, there is potential for the occupant to be displaced laterally before the airbag is triggered. Such displacement prior to activation reduces the effectiveness of the side airbag. In the case where a sliding vehicle crashes into a solid pole in an area of the side of the car that has less structure, like the passenger door, an acceleration based deployment system would not deploy the airbag until significant intrusion has taken place. The pre-crash sensor described here in a side looking application would give the safety system the ability to trigger the airbags prior to contact with the pole, and making the airbag more effective in protecting the occupant from the pole intrusion.

In a rearward looking application, the system may be used with further benefit to the host vehicle's occupants. Advance knowledge of a rear-end collision prior to contact gives the host vehicle's safety system time to move any reclined seats to a more safe upright position. The safety system has time to take up the seatbelt slack with an electric pre-tensioner to make the seatbelt more effective. Modifying the host vehicle structure is also possible with collision warning prior to impact. An expandable rear bumper could be deployed and help to absorb additional crash energy that would otherwise be transferred to the host vehicle occupants.

Additional benefits and advantages of the present invention will become apparent to those skilled in the art to which the present invention relates from the subsequent description of the preferred embodiment and the appended claims, taken in conjunction with the accompanying drawings.

### BRIEF DESCRIPTION OF THE DRAWINGS

FIG. 1 is an overhead view of a representative motor vehicle incorporating a system for sensing a collision and controlling deployment of a safety system in accordance with the present invention;

FIG. 2 is a signal and decision flow chart regarding the radar sensor of the sensor system of this invention;

FIG. 3 is a signal and decision flow chart regarding the vision systems of the sensor system of this invention;

FIG. 4 is a flow chart showing the integration of the radar output and the vision output to control the safety device; and

FIG. 5 is a flow chart showing feature level fusion logic where similar features from each sensor are combined to control the safety device based on the combined multi-sensor fused features.

### DETAILED DESCRIPTION OF THE INVENTION

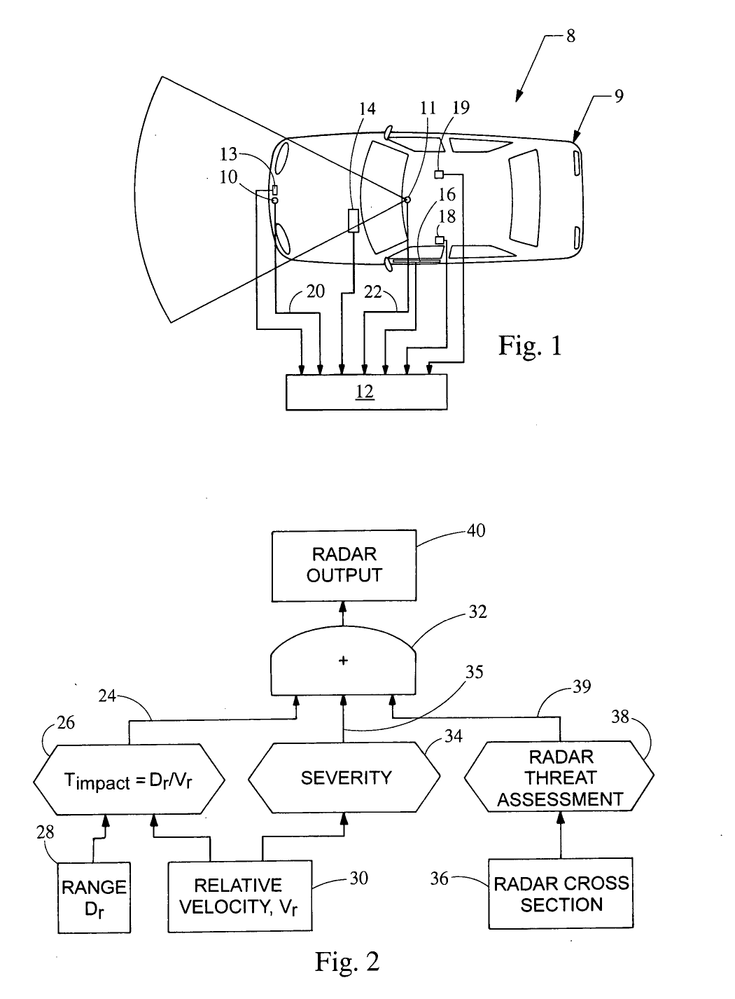

Now referring to FIG. 1, a system 8 is shown with an associated vehicle 9. The system 8 is configured for a forward looking application. However, the system 8 can be configured to look rearward or sideways with the same ability to sense an approaching object and prepare the vehicle 9 for the crash. In a side-looking, or rearward looking application, the sensors would have overlapping fields of view, as shown in the forward looking application in FIG. 1.

The sensor system 8 includes a radar sensor 10 which receives a radio frequency signal, preferably in the microwave region emanating from an antenna (not shown). Radar sensor 10 provides radar output 20 to an electronic control module (ECM) 12. A vision sensor 11 is preferably mounted to an upper portion of the vehicle 9, such as, along the windshield header aimed forward to provide vision information. Vision sensor 11 provides vision output 22 to an ECM 12. The ECM 12 combines radar output 20 and the vision output 22 to determine if a collision is imminent and deploy a safety device.

In addition to deploying the safety device, the ECM 12 may adjust deployment characteristics based on the vision output, the radar output, or both. For example, the ECM 12 is an electrical communication with an external airbag 13 to provide control signals that adjust the deployment velocity and deployment force of the external airbag 13 based on the radar and vision output. As the system 9 senses the range and closing velocity of an object, the system 9 uses the sensed information to calculate a time to impact. With longer time to impact, the external airbag 13 is deployed more slowly and with less force, thereby reducing the potential impact on the sensed object. In addition, with more time the external airbag may be filled to a larger size offering a higher level of energy absorption.

Similarly, control signals are also received by an internal airbag 14 from the ECM 12. The deployment velocity and deployment force of the internal airbag 14 is adjusted based on a time to impact, thereby reducing the potential impact on the occupant.

To provide control signals that adjust the deployment force of an expandable structure 16 based on the radar or vision output, the ECM 12 is in electrical communication with the expandable structure 16. Expandable structures include devices ,such as, expanding bumpers or pressurized body panels, The deployment force of the expandable structure 16 may be adjusted based on the bearing or size of the object, to better manage the affect of the expandable structure 16 on the structural integrity of the vehicle 9.

The ECM 12 is in electrical communication with a seat belt pre-tensioner 18 to provide control signals that adjust seat belt tension based on the radar or vision output. Based on the bearing or closing velocity of the object, the seat belt tension may be adjusted to better secure the occupant.

To provide control signals that adjust a seat angle and position provided by a seat positioner 19 based on the radar or vision output, the ECM 12 is in electrical communication with the seat positioner 19. The position and angle may be adjusted based on the bearing and closing velocity, to better position the occupant for impact.

Although, specific examples are provided above it is readily contemplated in accordance with the present invention, that one or all of the measurements provided by each of the sensors may be used in adjusting various deployment characteristics of a safety device as required.

Now with reference to FIG. 2, a diagram of the signal and decision flow related to radar sensor 10 is provided. The radar sensor 10 analyzes a radio frequency signal reflected off an object to obtain a range measurement 28, a closing velocity 30, and a radar cross section 36.

A time of impact estimate 26 is calculated based on range measurement 28 and the closing velocity 30. The range measurement 28 is the distance between the object and vehicle 9. Radar sensor 10 provides distance information with high accuracy, typically within 5 cm. The closing velocity 30 is a measure of the relative speed between the object and the vehicle 9. The time of impact estimate 26 is provided to block 32 along input 24. The time of impact estimate 26 is compared with the necessary time to deploy the safety device, such as an external air bag. Typically deployment time of an external airbag is between 200 ms and 30 ms. In addition, the range measurement 28 is compared with the necessary clearance distance from the vehicle 9 to deploy the safety device. Typically clearance distance for an external air bag is between 100 mm to 800 mm.

The closing velocity 30 is also used to determine the severity of impact as denoted by block 34. High closing velocities are associated with a more severe impact, while lower closing velocities are associated with a less severe impact. The severity of impact calculation is provided to block 32 as input 35.

The radar cross section 36 is a measure of the strength of the reflected radio frequency signal. The strength of the reflected signal is generally related to the size and shape of the object. The size and shape is used to access the threat of the object, as denoted by block 38. The threat assessment from block 38 is provided to block 32 as input 39. Block 32 of the ECM 12 processes the time of impact, severity of impact, and threat assessment to provide a radar output 40.

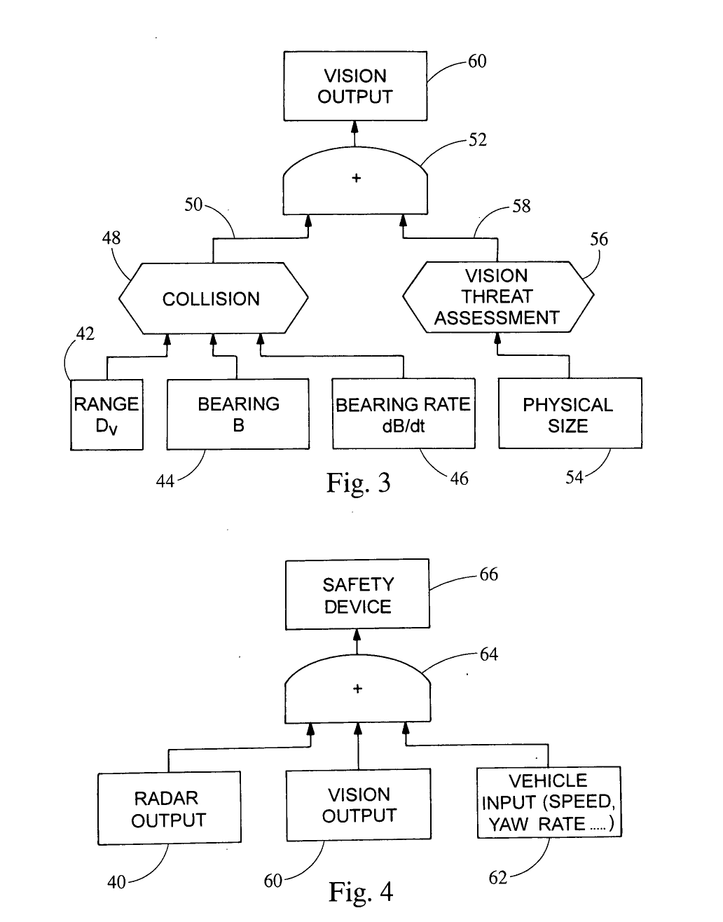

FIG. 3 provides a signal and decision flow chart related to the processing of information from vision sensor 11. The vision sensor 11 provides a vision range measurement 42, a bearing valve 44, a bearing rate 46, and a physical size 54 of the object.

By using a stereo pair of cameras or a light modulating 3 dimensional imaging sensor, the vision sensor 11 can determine the vision range measurement 42 to indicate the distance from the vehicle 9 to the object. The bearing valve 44 is related to an angular measure of object with respect to a datum of vehicle 9 (e.g. an angular deviation from a longitudinal axis through the center of the vehicle 9). The rate of change of the bearing valve 44, with respect to time, is the bearing rate 46. The vision range measurement 42, bearing valve 44, and the bearing rate 46 are used to generate a collision determination as denoted by 48. The collision determination from block 48 is provided as input 50 to block 52.

The vision sensor 11 also measures the physical size 54 of the object. The physical size 54 is used to assess the threat of the object, as denoted by block 56. The threat assessment is provided to block 52 as input 58. The collision determination from block 48 and the threat assessment from block 56 are used in block 52 to generate vision output 60.

FIG. 4 illustrates the integration of the radar output 40 and vision output 60 to generate control signals for a safety device 66. Both the radar sensor 10 and vision sensor 11 independently provide measurements to the ECM 12. However, ECM 12 considers measurements from the radar output 40 and the vision output 60 in block 64 along with vehicle parameters 62, such as vehicle speed, yaw rate, steering angle, and steering rate. The vehicle parameters 62 are evaluated in conjunction with the radar output 40 and the vision output 60 to enhance the reliability of the deployment decision and further adjust the deployment characteristics of the safety device 66.

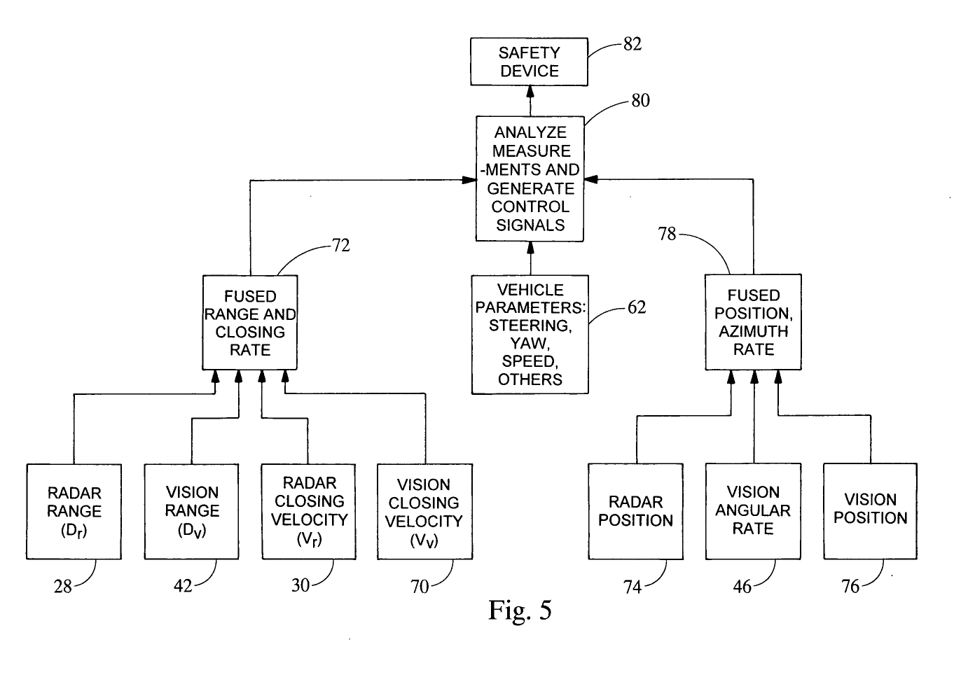

Referring now to FIG. 5, since each sensor has some very accurate features and some less accurate features, sensor system 10 may also be configured to combine the attributes of both radar sensor 10 and vision sensor 11 to provide control signals to the safety device 82. The radar output includes the range measurement 28, the radar closing velocity 30, and the radar position 74, while the vision output includes the vision range measurement 42, vision closing velocity 70, vision bearing rate 46, and vision bearing valve 44. The control signals 80 are based on a combination of radar and vision measurements from each sensor. The combining of discrete measurements from separate sensors to improve reliability of a measurement is referred to as feature fusion.

For example, the closing velocity 30 as measured by radar sensor 10 is combined with closing velocity 70 as measured by vision sensor 11 to determine a fused closing velocity as denoted by block 72. Similarly, the range measurement 28 from radar sensor 10 is fused or combined with the vision range measurement 42 as measured by vision sensor 16 to determine a fused range measurement, also denoted by block 72. The precision of the fused range measurement is achieved primarily through radar sensor 14. Although the vision range measurement 42 is not as accurate as the radar range measurement 28, comparison between the radar range measurement 28 and the vision range measurement 42 provides improved reliability. In addition, the vision range measurement 42 is accurate enough to enable correlation of features and fusion with the radar sensor 14.

In order to correlate features from different sensors a reference must be used to associate each similar measurement as sensed by each independent sensor. Use of a reference is increasingly important in a multiple target scenario to decrease the likelihood of attributing a measurement to the wrong target. Since both sensors determine range, it is the reference used to as a basis to combine all features in the feature fusion process.

The radar position 74, vision bearing 44, and vision bearing rate 46 are combined to determine a fused position and azmuth rate as denoted by block 78. Similarly, the radar cross section 36 and the physical size measurement 54 from the vision sensor 11, may be combined into a fused size measurement as denoted by block 76. The fused range and closing range in block 72, the fused position and azmuth rate in block 78, and the fused size measurement in block 76 are combined with other vehicle parameters 62 in block 80. The analysis, in block 80, of attributes from both the radar sensor 10 and the vision sensor 11, in the form of the fused feature measurements, provides control signals with high reliability.

While the above description constitutes the preferred embodiment of the present invention, it will be appreciated that the invention is susceptible to modification and change without departing from the proper scope and fair meaning of the accompanying claims.

1. A system for a motor vehicle, the system comprising:
a sensor configured to sense an impending collision and generate sensor signals corresponding to characteristics of an object of the impending collision;
an electronic control module in communication with the sensor system to receive the sensor signals, the electronic control module being configured to generate control signals based on the sensor signals;
a safety device in communication with the electronic control module, the safety device being configured to adjust deployment characteristics based on the control signals.

2. The system according to claim 1, wherein the deployment characteristics are adjusted based on a range of the object.

3. The system according to claim 1, wherein the deployment characteristics are adjusted based on a closing velocity of the object.

4. The system according to claim 1, wherein the deployment characteristics are adjusted based on a size of the object.

5. The system according to claim 1, wherein the deployment characteristics are adjusted based on the bearing of the object.

6. The system according to claim 1, wherein the safety device is an airbag.

7. The system according to claim 6, wherein the airbag is an external airbag.

8. The system according to claim 6, wherein the deployment velocity of the airbag is based on the control signals.

9. The system according to claim 6, wherein the deployment force of the airbag is based on the control signals.

10. The system according to claim 1, wherein the safety device is a seatbelt pre-tensioner.

11. The system according to claim 10, wherein the amount of seatbelt tension provided by the seat belt pre-tensioner is based on the control signals.

12. The system according to claim 1, wherein the safety device is a seat positioner.

13. The system according to claim 12, wherein the seat position provided by the seat positioner is based on the control signals.

14. The system according to claim 1, wherein the safety device is an expandable structure.

15. The system according to claim 14, wherein the force applied to activate the expandable structure is based on the control signals.

16. A system for a motor vehicle, the system comprising:
a sensor system including a vision sensor and a radar sensor configured to sense an impending collision and generate vision output and radar output corresponding to characteristics of an object of the impending collision;
an electronic control module in communication with the sensor system to receive the vision output and the radar output, the electronic control module being configured to generate control signals based on the vision output and the radar output;
a safety device in communication with the electronic control module, the safety device being configured to adjust deployment characteristics based on the control signals.

17. The system according to claim 16, wherein the deployment characteristics are adjusted based on a range of the object.

18. The system according to claim 17, wherein the deployment characteristics are adjusted based on a closing velocity of the object.

19. The system according to claim 18, wherein the deployment characteristics are adjusted based on a size of the object.

20. The system according to claim 19, wherein the deployment characteristics are based on the bearing of the object.

21. The system according to claim 16, wherein the vision output and the radar output are combined to form fused measurements and the deployment characteristics of the safety system are adjusted based on the fused measurements.

22. The system according to claim 16, wherein the safety device is an airbag.

23. The system according to claim 22, wherein the airbag is an external airbag.

24. The system according to claim 22, wherein the deployment velocity of the airbag is based on the control signals.

25. The system according to claim 22, wherein the deployment force of the airbag is based on the control signals.

26. The system according to claim 16, wherein the safety device is a seatbelt pre-tensioner, and wherein the amount of seatbelt tension provided by the seat belt pre-tensioner is based on the control signals.

27. The system according to claim 16, wherein the safety device is a seat positioner, and wherein the seat position provided by the seat positioner is based on the control signals.

28. The system according to claim 16, wherein the safety device is an expandable structure, and wherein the force applied to activate the expandable structure is based on the control signals.
